(19) United States
(12) Patent Application Publication
(10) Pub. No.: US 2013/0198398 A1
(43) Pub. Date: Aug. 1, 2013

(54) SYSTEM AND METHOD FOR AN IMPROVED NETWORK CLIENT DEVICE

(71) Applicant: Raketu Communications, Inc., New York, NY (US)

(72) Inventor: Gregory T. Parker, New York, NY (US)

(73) Assignee: RAKETU COMMUNICATIONS, INC., New York, NY (US)

(21) Appl. No.: 13/755,202

(22) Filed: Jan. 31, 2013

Related U.S. Application Data
(60) Provisional application No. 61/593,745, filed on Feb. 1, 2012.

(51) Int. Cl. H04L 29/06

(52) U.S. Cl. CPC H04L 65/1069
USPC 709/228

(57) ABSTRACT

A system and method for improving the efficiency of inbound audio and video calls communications and messaging which reduces the use of resources of a mobile device is disclosed. In the invention, a mobile device periodically and intermittently connects and polls the gateway server to determine if an inbound audio or video call has been requested. If a request for an audio or video call is retrieved, the mobile device allows the user to accept or reject the call, which choice is sent to the gateway server. If the call is accepted, the mobile connects to the gateway server with an authorization to answer the call. The invention periodically polls the gateway server for messages and is not constantly and persistently connected. As the mobile device is not continuously connected or in the process of constant reconnection, the mobile device's use of resources (battery, CPU, and network) is reduced.

Priority is claimed from U.S. provisional patent application Ser. No. 61/593,745, filed Feb. 1, 2012.

### FIELD OF INVENTION

The present invention relates generally to audio and video communications, messages and signals, and more particularly to systems and methods for reducing resource requirements for mobile devices receiving audio and video calls.

### BACKGROUND

Mobile devices connecting to a network typically carry out many forms of communications activities, including audio and video communications. For audio and video communications, a common implementation is to deploy a continuously connected application to a communications server. This allows the server to receive requests that can be relayed to the mobile device informing the mobile device of incoming audio and video calls. This type of persistent deployment leads to constant resource utilization on the mobile device, specifically negatively impacting battery, CPU (Central Processing Unit), and network resources unnecessarily. In the invention, resource reduction of battery, CPU, and network are achieved over conventional methods for receiving inbound voice and video calls on mobile devices.

One common implementation on mobile devices for receiving inbound audio and video call requests is to setup and maintain a constantly connected state from the mobile device to a server which is connected via a network to the inbound call initiator, FIG. 1 and

FIG. 2 are block diagrams illustrating such prior art systems. The system includes a central gateway server (320) and in the case of audio, a central Session Initiation Protocol (SIP) server (310), a mobile call receiver (100) and a call initiator (200). The mobile call receiver (100) is persistently connected to either the central gateway server (320) in the case of video, or persistently connected to either a central gateway server (320) that is connected to a central SIP server (310) or directly connected to a central SIP server (310) in the case of audio. If the mobile call receiver (100) was to become disconnected from the central server (310 or 320), it would not be able to receive any calls. In this way, the mobile call receiver (100) continuously seeks to be connected to the central server (310 or 320). If the mobile call receiver temporarily becomes disconnected from the central server (310 or 320), it goes into a state of automated retries as it attempts to reconnect. This results in constant usage of the mobile devices resources, specifically the CPU, battery and network, even when the device is not connected. In order to initiate an inbound audio call, the call initiator (200) sends a call message (1) to either the central SIP server (310), if the call is initiated via a standard mobile or landline phone voice protocol, or the central gateway server (320) if the call is initiated via the central gateway protocol. The inbound call message request (2) is relayed from the central server (310 or 320) directly to the mobile call receiver (100) where the call receiver determines whether to answer or reject the request which is relayed back (3) to the central server (310 or 320), which relays the response message (4) back to the call initiator (200).

If a prior art mobile device's normal connection to the network is interrupted, any inbound call message request would be rejected at the central gateway server, which would not have a connection to the mobile device.

Although the conventional systems of FIG. 1 and FIG. 2 perform adequately, there are very high costs on mobile resources associated with such systems. One problem is that the battery life of mobile devices is significantly impacted and can result in the reduction of over 75% of a mobile device battery power availability using the conventional system.

Another problem is that using the conventional system, the mobile device's CPU is constantly and persistently being utilized, which results in increased power consumption and reduced processing capacity availability to process other activities, tasks and applications on the mobile device.

Current efforts to address the power consumption problem are directed toward improvements in power supplies and battery life, as well as improved and more efficient processors. Such efforts may require replacement of existing devices, rather than providing an improvement in the operation of existing devices.

Another problem is that using the conventional system, the mobile device's network connectivity is persistently engaged and being accessed. This results in dramatically increased bandwidth utilization by the mobile device, which adversely affects the mobile device's ability to service other applications that require network access and has the potential to dramatically increase the cost of operation to the mobile device owner (example: increased mobile data roaming charges based on usage). The persistent connection to the network also presents a greater load on the network resources.

A solution to these problems would provide a mobile device that periodically polls the server with requests for any inbound audio and video call signals and or messages. The mobile device would not be constantly connected or in a state of constant reconnection should the mobile device be temporarily disconnected from the network. By not being constantly connected, the invention system and method significantly reduces the resource requirements over conventional methods on a mobile device.

### SUMMARY OF THE INVENTION

The following is a summary of the invention in order to provide a basic understanding of some aspects of the invention. This summary is not intended to identify key/critical elements of the invention or to delineate the scope of the invention. Its sole purpose is to present some concepts of the invention in a simplified form as a prelude to the more detailed description that is presented later.

The present invention provides a client device that periodically polls a server, requesting any inbound audio and video call signals and or messages. The mobile device is not constantly connected nor would the client device be in a state of constant reconnection in the event of a temporarily disconnection. The client device initiates a periodic request, which is an initial temporary connection to the server. The server responds with an appropriate signal and or message. If the server responds that there is no inbound audio/video call request, the client device disconnects, frees up resources, and waits for the next periodic poll. If the server responds that there is an inbound audio/video call request, the client device can do any of the following: (a) disconnects; (b) displays an appropriate choice to the user (example: answer or ignore) and waits for the user response; or (c) times out after a period of time or when the inbound call request is no longer valid. If the user chooses to ignore, the client device can either send no response or send an ignore message/signal to the server, which relays the ignore signal to the call initiator, and may optionally present the initiator with the ability to leave an audio/video voicemail. If the user chooses to answer the call, the client device connects to the central server and sends an answer message/signal to the server which would then relay the answer message/signal to the call initiator.

The present invention, as depicted in FIG. 3 and FIG. 4, relates generally to systems and methods for audio and video communications, messages and signals, and more particularly to systems and methods for reducing resource requirements for mobile devices receiving audio and video calls. The invention can readily be implemented on mobile devices, but can also be used to conserve resources on other forms of client devices such as laptops or desktop computers.

The present invention provides a messaging and signaling system that results in reducing mobile device resource requirements, is highly scalable, and highly flexible in its implementation. More specifically, the invention reduces the power consumption requirement, the central processing unit (CPU) resource requirement, and the network resource requirement on mobile devices receiving audio and video calls.

The present invention reduces power consumption of the client device, due to the client device not having a constant and persistent connection to the server, and due to the client device not having a persistent connection retry when the network is not available. The reduction in power consumption increases the battery life, the amount of time that a client device can operate before recharging.

The present invention reduces central processing unit (CPU) cycle consumption of the client device, due to the client device not having a constant and persistent connection to the server, and due to the client device not having a persistent connection retry when the network is not available. The reduction in CPU cycle consumption increases the device's available capacity to process other activities, tasks and applications, increases battery life, and results in a faster, richer user experience.

The present invention reduces network consumption due to the mobile device not having a constant and persistent connection to the server over a network. This results in dramatically decreased bandwidth utilization by the mobile device, which increases the mobile devices ability to service other applications that require network access, increases battery life, and has the potential to dramatically decrease the cost of operation to the mobile device owner (example: decreased mobile data roaming charges based on usage over conventional systems).

To the accomplishment of the foregoing and related ends, certain illustrative aspects of the invention are described herein in connection with the description and the annexed drawings. These aspects are indicative of various ways in which the invention may be practiced, all of which are intended to be covered by the present invention. Other advantages and novel features of the invention may become apparent from the following detailed description of the invention when considered in conjunction with the drawings.

### BRIEF DESCRIPTION OF THE DRAWINGS

FIG. 1 is a block diagram illustrating a Conventional Inbound Voice Call Network Flow.

FIG. 2 is a block diagram illustrating a Conventional Inbound Video Call Network Flow.

FIG. 3 is a block diagram illustrating a Resource Reduced Inbound Voice Call Network Flow—an aspect of the present invention.

FIG. 4 is a block diagram illustrating a Resource Reduced Inbound Voice/Video Call Network Flow—an aspect of the present invention.

### DETAILED DESCRIPTION OF THE PREFERRED EMBODIMENT

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component” and “system” and “server” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

It is to be appreciated that, for purposes of the present invention, any or all of the functionality associated with modules, systems and/or components discussed herein can be achieved in any of a variety of ways (e.g. combination or individual implementations of active server pages (ASPs), common gateway interfaces (CGIs), application programming interfaces (API's), structured query language (SQL), component object model (COM), distributed COM (DCOM), system object model (SOM), distributed SOM (DSOM), ActiveX, common object request broker architecture (CORBA), database management systems (DBMSs), relational database management systems (RDBMSs), object-oriented database management system (ODBMSs), object-relational database management systems (ORDBMS), remote method invocation (RMI), C, C++, Java, practical extraction and reporting language (PERL), applets, HTML, dynamic HTML, server side includes (SSIs), extensible markup language (XML), portable document format (PDF), wireless markup language (WML), standard generalized markup language (SGML), handheld device markup language (HDML), graphics interchange format (GIF), joint photographic experts group (JPEG), binary large object (BLOB), other script or executable components).

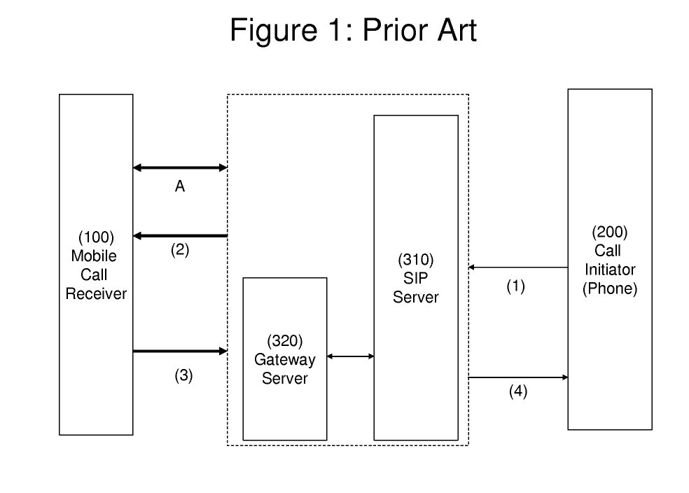

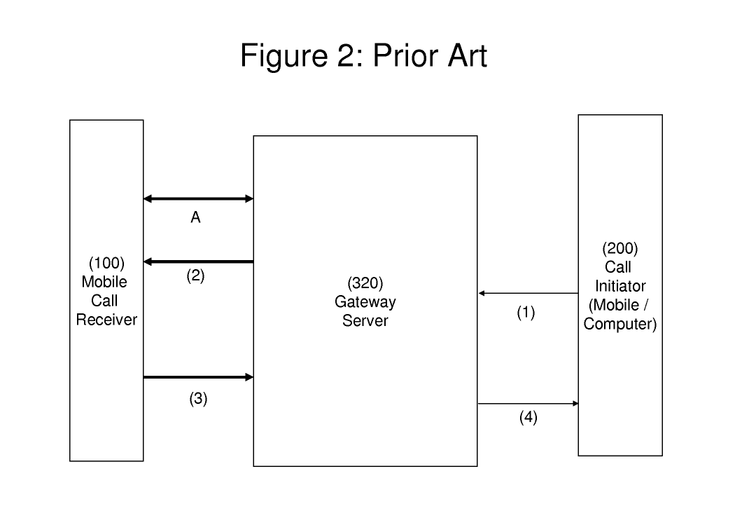

FIGS. 1 and 2 are block diagrams of prior art systems, showing a mobile call receiver (100) connecting to a call initiator (200) through a central gateway server (320) and a central gateway server (320) using a SIP server (310). In FIGS. 1 and 2, the persistent connection of the prior art is depicted by a solid arrow line A.

The present invention presents an approach to system efficiency that is contrary to current industry practice. The communications industry traditionally pursues a model where each client device is persistently connected to a network. In contrast, the present invention presents a periodically or intermittently connected model.

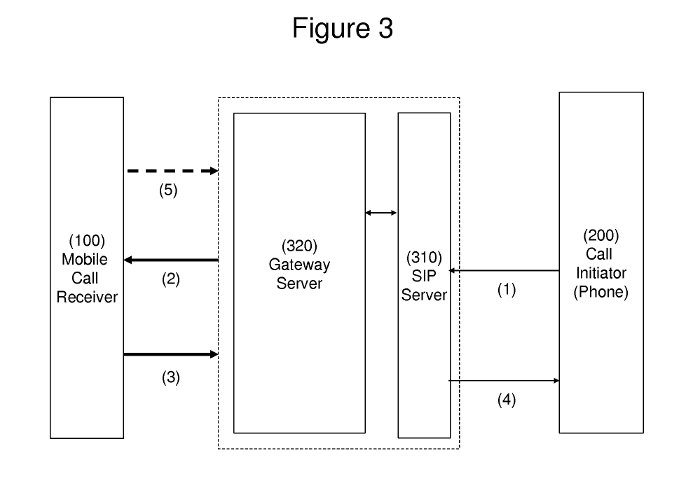

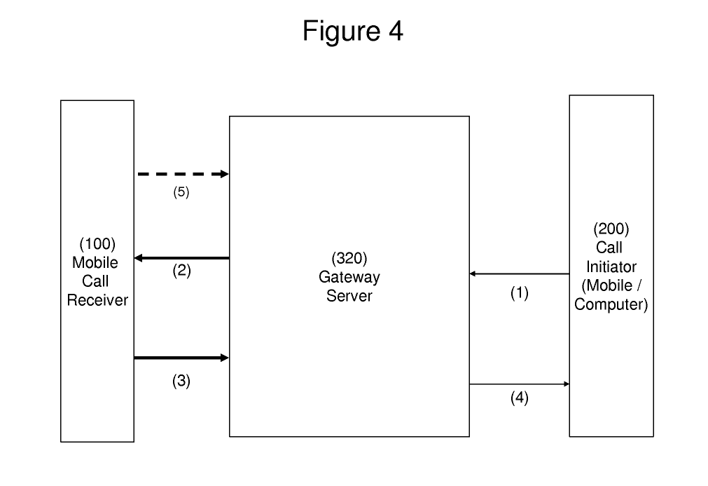

FIG. 3 is a block diagram illustrating a resource reduced inbound voice call network flow according to an aspect of the present invention. In FIGS. 3 and 4, the intermittent connection of the present invention is depicted by a dashed arrow line (5).

The system includes a central gateway server (320) and a central Session Initiation Protocol (SIP) server (310), a mobile call receiver (100) and a call initiator (200). The mobile call receiver (100) is not persistently connected to the central gateway server (320). In order to initiate an inbound audio call, the call initiator (200) sends a call message (1) to the central SIP server (310) which relays the inbound request to the central gateway server (320), which stores the inbound request destined for the specific mobile call receiver (100). The mobile call receiver (100) periodically polls the central gateway server (320) by sending a request (5) at a set, but variable, periodic time period (example, every 30 seconds).

It is only when this request is sent (5) and the response received (2) that the mobile call receiver (100) is connected to the network for the purposes of determining if there is an incoming call. If the mobile call receiver (100) is not connected to the network, the request is not attempted and no network, battery or CPU resources are utilized by the mobile call receiver (100), and the request is rescheduled to the next time period. If the message request (5) succeeds and the response (2) is no pending inbound calls, the mobile call receiver (100) disconnects from the network and ceases activity until the next time period. If the message request (5) succeeds and the response (2) is a pending inbound call, the mobile call receiver (100) disconnects from the network and offers the user an option to answer or ignore the call (which may include audible and visual alerts). If the user ignores the call (3), the central gateway (320) times out the inbound call request, sends the response (4) to the call initiator (200) optionally offering the ability for them to leave a voice mail. If the user accepts the call (3), the mobile call receiver (100) directly connects to the central gateway server (320) which connects to the central SIP server (320) which sends an accept message (4) to the call initiator (200) and the call is connected.

In accordance with the present invention, an inbound call request (2) can be retained at the central gateway server (320) during periods when the mobile call receiver (100) is not polling to the central gateway server. In prior art systems, a failure to have a connection with a mobile call receiver will cause the central gateway server to fail to complete the call, advising the call initiator that the mobile call receiver is unavailable and provide an option to leave a voice mail message. The present invention provides for the central gateway server to allow the mobile call receiver to connect, resulting in a greater probability of a completed connection.

FIG. 4 is a block diagram illustrating a resource reduced inbound voice/video call network flow according to an aspect of the present invention.

The system includes a central gateway server (320), a mobile call receiver (100) and a call initiator (200). The mobile call receiver (100) is not persistently connected to the central gateway server (320). In order to initiate an inbound audio or video call, the call initiator (200) sends a call message (1) to the central gateway server (320), which stores the inbound request destined for the specific mobile call receiver (100). The mobile call receiver (100) periodically polls the central gateway server (320) by sending a request (5) at a set, but variable, periodic time period (example, every 30 seconds). It is only when this request is sent (5) and the response received (2) that the mobile call receiver (100) is connected to the network for the purposes of determining if there is an incoming call. If the mobile call receiver (100) is not connected to the network, the request is not attempted and no network, battery or CPU is utilized by the mobile call receiver (100), and the request is rescheduled to the next time period. If the message request (5) succeeds and the response (2) is no pending inbound calls, the mobile call receiver (100) disconnects from the network and ceases activity until the next time period. If the message request (5) succeeds and the response (2) is a pending inbound call, the mobile call receiver (100) disconnects from the network and offers the user an option to answer or ignore the call (which may include audible and visual alerts). If the user ignores the call (3), the central gateway (320) times out the inbound call request, sends the response (4) to the call initiator (200) optionally offering the ability for them to leave a voice or video mail. If the user accepts the call (3), the mobile call receiver (100) directly connects to the central gateway server (320) which sends an accept message (4) to the call initiator (200), which connects to the central gateway server (320) and the call is connected.

Another embodiment of the invention is a software module running on a mobile call receiver (100), where the mobile call receiver (100) is configured to maintain a persistent connection with a central gateway server (320). The software module or application interrupts the persistent connection normally active on the mobile call receiver (100) and may also suspend processor operations on the mobile call receiver (100). In this manner, the software module converts the persistent connection between the mobile call receiver (100) and the central gateway server (320) into an intermittent connection (5).

Another embodiment of the invention may comprise a software application or library or routine which is run on the client device that either prevents the persistently connected communications software network connection for incoming voice or video calls from connecting or attempting to connect to the gateway server, or works in conjunction with communications software specifically written to work in an intermittent connection system. The software/library/routine periodically sends a message over the network to the gateway server, which responds with either “true” there is an inbound call waiting or “false” there is no inbound call waiting. If there is no call waiting, the software/library/routine goes to sleep, waiting to wake up at the periodic interval to send the next message request to the voice gateway server. If there is a call waiting, the software application/library/routine alerts the user of an incoming call. If the user rejects/ignores the call or the call times out, the alert to the user is discarded and the software/library/routine goes to sleep, waiting to wake up at the periodic interval to send the next message request to the voice gateway server. If the user accepts the call, the software/library/routine informs the communications software to connect to the voice gateway and accept the call. Once the call is accepted, the software/library/routine enters an inactive state until the call is concluded.

A variation on the invention will allow for variations in the period of time between network connection attempts, rather than having a pre-set time period. The invention can determine an appropriate interval based upon current usage of the client device or other network characteristics, or the user may provide the interval period.

The present invention reduces power consumption due to the mobile device not having a constant and persistent connection to the server, and due to the mobile device not having a persistent connection retry when the network is not available. The reduction in power consumption increases the battery life, the amount of time that a mobile device can operate before recharging.

The present invention reduces central processing unit (CPU) cycle consumption due to the mobile device not having a constant and persistent connection to the server, and due to the mobile device not having a persistent connection retry when the network is not available. The reduction in CPU cycle consumption increases the devices available capacity to process other activities, tasks and applications, increases battery life, and results in a faster, richer user experience.

The present invention reduces network consumption due to the mobile device not having a constant and persistent connection to the server over a network. This results in dramatically decreased bandwidth utilization by the mobile device, which increases the mobile devices ability to service other applications that require network access, increases battery life, and has the potential to dramatically decrease the cost of operation to the mobile device owner (example: decreased mobile data roaming charges based on usage over conventional systems).

While certain novel features of the present invention have been shown and described, it will be understood that various omissions, substitutions and changes in the forms and details of the device illustrated and in its operation can be made by those skilled in the art without departing from the spirit of the invention. What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

I claim:

1. A communications network comprising:
a communications server configured to receive and transmit messages between a plurality of client devices, and
where at least one client device initiates a connection to the communications server on an intermittent basis, and if no messages are to be transmitted from the communications server, the client device disconnects from the communications server.

2. The communications network of claim 1, where the communications server is configured to recognize that the client device is not maintaining a persistent connection and allows an incoming message to be held at the communications server for a period of time to allow the client device to initiate a connection:

3. The communications network of claim 2, where the communications server determines whether the client device is available for message delivery, and allows for a delay in determining client device availability for message delivery:

4. The communications network of claim 1, where the at least one client device presents a message to a user, advising of an incoming message:

5. The communications network of claim 4, where the at least one client device is configured to allow the user to choose to accept or reject an incoming message, and communicates the user's choice to the communications server:

6. The communications network of claim 1, further comprising:
a timing module at the client device that determines when the client device will initiate a connection to the communications server.

7. An improved network client device, the network client device comprising a power supply, a processor, and a communication circuit configured to transmit and receive messages between the client device and a network, the improvement comprising:
a timing module for activating the communication circuit to initiate a connection to the network.

8. The network client device of claim 7, where the network client device is capable of a persistent connection to the network, but only seeks a connection to the network on an intermittent basis.

9. The network client device of claim 7, where the timing module interrupts the communication circuit to disrupt the connection to the network.

10. The network client device of claim 7, where the timing module instructs the power supply to reduce the power to the processor.

11. The network client device of claim 7, where the timing module instructs the processor to enter a low power state.

12. A method of operating a network client device, comprising the steps of:
initiating a connection to a network;
determining if there is an inbound message for the client device; and
terminating the connection to the network if no inbound message is detected.

13. The method of claim 12, further comprising the steps of:
putting the network client device into a wait state; and
repeating the step of initiating a connection the network.
